(19) United States
(12) Patent Application Publication
(10) Pub. No.: US 2024/0005670 A1
(43) Pub. Date: Jan. 4, 2024

(54) APPARATUS FOR DRIVER ASSISTANCE AND METHOD OF CONTROLLING THE SAME

(71) Applicant: HL KLEMOVE CORP., Incheon (KR)

(72) Inventor: Daichang RO, Seoul (KR)

(21) Appl. No.: 18/217,932

(22) Filed: Jul. 3, 2023

(30) Foreign Application Priority Data
Jul. 4, 2022 (KR) 10-2022-0081973

(51) Int. Cl. G06V 20/58; G06V 20/56; B60W 50/14

(52) U.S. Cl. CPC G06V 20/582; G06V 20/588; B60W 50/14; B60W 2050/146; B60W 2420/42

(57) ABSTRACT

Disclosed herein is an apparatus including a camera installed in a vehicle, having a forward field of view of the vehicle, and configured to acquire image data, and a controller configured to process the image data. The controller identifies whether the vehicle exits from a road at an exit of the road on which the vehicle travels, identifies a plurality of speed limit signs from the image data, selects a speed limit sign to identify a speed limit among the plurality of speed limit signs based on whether the vehicle exits from the road, and identifies a speed limit of the selected speed limit sign.

### CROSS-REFERENCE TO RELATED APPLICATION

This application claims the benefit of Korean Patent Application No. 10-2022-0081973, filed on Jul. 4, 2022 in the Korean Intellectual Property Office, the disclosure of which is incorporated herein by reference.

### BACKGROUND

### 1. Field

Embodiments of the present disclosure relate to an apparatus for driver assistance capable of recognizing a speed limit sign on a road and a method of controlling the same.

### 2. Description of the Related Art

Recently, research on vehicles equipped with an advanced driver assist system (ADAS) for actively providing information on a vehicle state, a driver state, and/or a surround environment in order to reduce a driver's burden and enhance convenience is actively progressing.

An ADAS, for example, an adaptive cruise control (ACC) system, is a convenience function of automatically maintaining an appropriate inter-vehicle distance to a preceding vehicle by detecting a distance to and speed of the preceding vehicle using a radar mounted on a front portion of a host vehicle and automatically decelerating or accelerating the host vehicle without driver's intervention. An intelligent speed limit assist (ISLA) system is a convenience function of recognizing a speed limit sign using a navigation device and a front camera to notify a driver of a speed limit and automatically controlling an ACC system to change a traveling speed to the limit speed.

At an exit of an exit section while driving on a highway, a driver may continuously drive on a straight road or may also exit to an exit lane.

Speed limits in a straight section and an exit section are different. In some cases, conventional ISLA systems may misrecognize a speed limit in a section in which a driver drives as a speed limit in a section irrelevant to an actual driving of the driver. That is, even when the vehicle drives on a straight road, the ISLA system may misrecognize a speed limit on an exit lane as a speed limit of a straight road. Therefore, there is a concern that the ISLA system may incorrectly warn a driver or perform incorrect control of an ACC system, thereby causing confusion to the driver.

### SUMMARY

Therefore, it is an aspect of the present disclosure to provide an apparatus capable of reducing misrecognition of a speed limit by accurately recognizing a road speed limit suitable for a traveling direction of a driver at an exit in an exit section.

Additional aspects of the disclosure will be set forth in part in the description which follows and, in part, will be obvious from the description, or may be learned by practice of the disclosure.

In accordance with one aspect of the present disclosure, an apparatus for driver assistance includes a camera installed in a vehicle, having a forward field of view of the vehicle, and configured to acquire image data, and a controller configured to process the image data. The controller identifies whether the vehicle exits from a road at an exit of the road on which the vehicle travels, identifies a plurality of speed limit signs from the image data, selects a speed limit sign to identify a speed limit among the plurality of speed limit signs based on whether the vehicle exits from the road, and identifies a speed limit of the selected speed limit sign.

The controller may identify whether the vehicle exits from the road at the exit based on at least one of an operation state or a last use history of a turn signal lamp of the vehicle.

In which the vehicle travels on a left-hand side, the controller may identify that the vehicle does not exit from the road based on a fact that the turn signal lamp is not in use or the last use history of the turn signal lamp is a right turn in a road environment.

The controller may select only a right speed limit sign among the plurality of speed limit signs, which is located to a right side of a main road, based on a result of identifying that the vehicle does not exit from the road and ignores the remaining speed limit signs.

In a road environment in which the vehicle travels on a left-hand side, the controller may identify that the vehicle exits from the road based on a fact that the last use history of the turn signal lamp is a left turn.

The controller may select only a left speed limit sign among the plurality of speed limit signs, which is located to a left side of an exit lane, based on a result of identifying that the vehicle exits from the road and ignores the remaining speed limit signs.

In a road environment in which the vehicle travels on a right-hand side, the controller may identify that the vehicle does not exit from the road based on a fact that the turn signal lamp is not in use or the last use history of the turn signal lamp is a left turn.

The controller may select only a left speed limit sign among the plurality of speed limit signs, which is located to a left side of a main road, based on a result of identifying that the vehicle does not exit from the road and ignores the remaining speed limit signs.

In a road environment in which the vehicle travels on a right-hand side, the controller may identify that the vehicle exits from the road based on a fact that the last use history of the turn signal lamp is a right turn.

The controller may select only a right speed limit sign among the plurality of speed limit signs, which is located to a right side of an exit lane, based on a result of identifying that the vehicle exits from the road and ignores the remaining speed limit signs.

In accordance with another aspect of the present disclosure, a method for driver assistance includes identifying whether a vehicle exits from a road at an exit of the road on which the vehicle travels, acquiring image data through a camera having a forward field of view of the vehicle, identifying a plurality of speed limit signs from the image data, selecting a speed limit sign to identify a speed limit among the plurality of speed limit signs based on whether the vehicle exits from the road, and identifying a speed limit of the selected speed limit sign.

The identifying of whether the vehicle exits from the road may include identifying whether the vehicle exits from the road at the exit based on at least one of an operation state or a last use history of a turn signal lamp of the vehicle.

The identifying of whether the vehicle exits from the road may include, in a road environment in which the vehicle travels on a left-hand side, identifying that the vehicle does not exit from the road based on a fact that the turn signal lamp is not in use or that the last use history of the turn signal lamp is a right turn.

The selecting of the speed limit sign to identify the speed limit may include selecting only a right speed limit sign among the plurality of speed limit signs, which is located to a right side of a main road, based on the identifying that the vehicle does not exit from the road and ignoring the remaining speed limit signs.

The identifying of whether the vehicle exits from the road may include, in a road environment in which the vehicle travels on a left-hand side, identifying that the vehicle exits from the road based on a fact that the last use history of the turn signal lamp is a left turn.

The selecting of the speed limit sign to identify the speed limit may include selecting only a left speed limit sign among the plurality of speed limit signs, which is located to a left side of an exit lane, based on the identifying that the vehicle exits from the road and ignoring the remaining speed limit signs.

The identifying of whether the vehicle exits from the road may include, in a road environment in which the vehicle travels on a right-hand side, identifying that the vehicle does not exit from the road based on a fact that the turn signal lamp is not in use or that the last use history of the turn signal lamp is a left turn.

The selecting of the speed limit sign to identify the speed limit may include selecting only a left speed limit sign among the plurality of speed limit signs, which is located to a left side of a main road, based on the identifying that the vehicle does not exit from the road and ignoring the remaining speed limit signs.

The identifying of whether the vehicle exits from the road may include, in a road environment in which the vehicle travels on a right-hand side, identifying that the vehicle exits from the road based on a fact that the last use history of the turn signal lamp is a right turn.

The selecting of the speed limit sign to identify the speed limit may include selecting only a right speed limit sign among the plurality of speed limit signs, which is located to a right side of an exit lane, based on the identifying that the vehicle exits from the road and ignoring the remaining speed limit signs.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a configuration of a driver assistance apparatus and a vehicle to which the driver assistance apparatus is applied in accordance with one embodiment;

FIG. 2 is a view illustrating fields of view of a camera, a radar, and a light detection and ranging (LiDAR) included in the driver assistance apparatus in accordance with one embodiment;

FIG. 3 is a flowchart illustrating an operation of the driver assistance apparatus in accordance with one embodiment;

FIG. 4 is a view illustrating recognizing a speed limit sign when the driver assistance apparatus in accordance with one embodiment predicts that a vehicle travels on a main road at an exit;

FIG. 5 is a view illustrating recognizing a speed limit sign when the driver assistance apparatus in accordance with one embodiment predicts that a vehicle exits to an exit lane;

FIG. 6 is a view illustrating recognizing a speed limit sign when a driver assistance apparatus in accordance with another embodiment predicts that a vehicle travels on a main road at an exit; and

FIG. 7 is a view illustrating recognizing a speed limit sign when the driver assistance apparatus in accordance with another embodiment predicts that a vehicle exits to an exit lane.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

The expression, “at least one of a, b, and c,” should be understood as including only a, only b, only c, both a and b, both a and c, both b and c, or all of a, b, and c.

Reference will now be made in detail to the exemplary embodiments of the present disclosure, examples of which are illustrated in the accompanying drawings, wherein like reference numerals refer to like elements throughout.

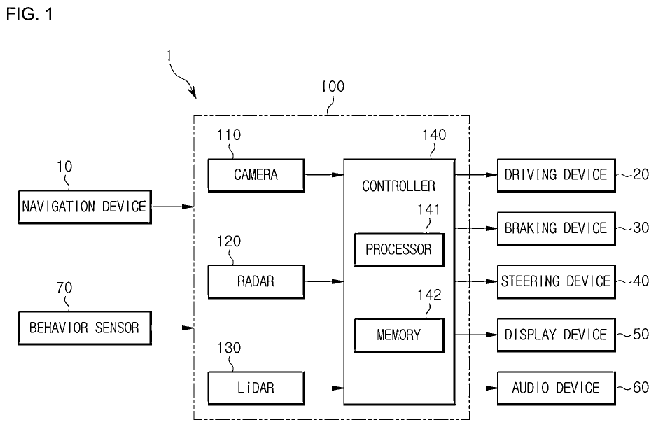

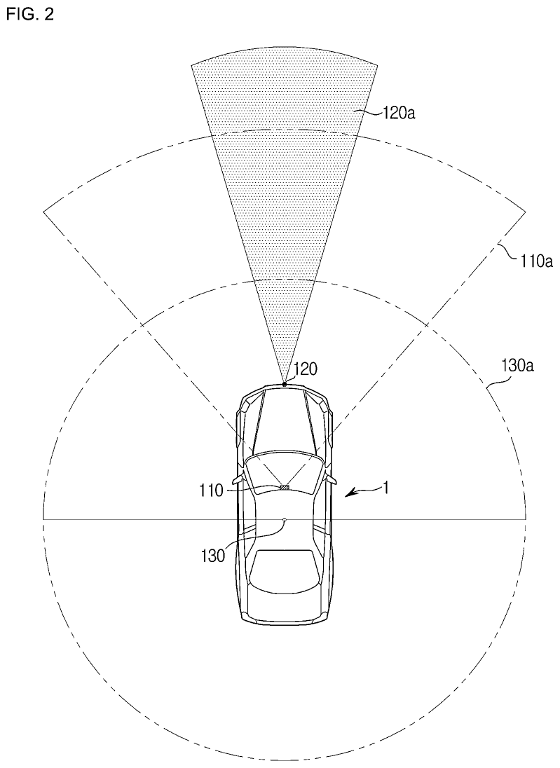

FIG. 1 is a view illustrating a configuration of a driver assistance apparatus and a vehicle to which the driver assistance apparatus is applied in accordance with one embodiment. FIG. 2 is a view illustrating fields of view of a camera, a radar, and a light detection and ranging (LiDAR) included in the driver assistance apparatus in accordance with one embodiment.

Referring to FIG. 1, a vehicle 1 may include a navigation device 10, a driving device 20, a braking device 30, a steering device 40, a display device 50, an audio device 60, a behavior sensor 70, and/or a driver assistance apparatus 100.

The navigation device 10, the driving device 20, the braking device 30, the steering device 40, the display device 50, the audio device 60, the behavior sensor 70, and/or the driver assistance apparatus 100 may communicate with one another via a vehicle communication network NT. For example, the electric devices 10, 20, 40, 50, 60, 70, and 100 included in the vehicle 1 may exchange data via Ethernet, media oriented systems transport (MOST), Flexray, controller area network (CAN), local interconnect network (LIN), etc.

The navigation device 10 may generate a route to a destination input by a driver and provide the generated route to the driver. The navigation device 10 may receive a global navigation satellite system (GNSS) signal from a GNSS and identify an absolute position (coordinates) of the vehicle 1 based on the GNSS signal. The navigation device 10 may generate the route to the destination based on the position (coordinates) of the destination input by the driver and a current position (coordinates) of the vehicle 1.

The navigation device 10 may provide map data and position information of the vehicle 1 to the driver assistance apparatus 100. In addition, the navigation device 10 may provide information on the route to the destination to the driver assistance apparatus 100. For example, the navigation device 10 may provide the driver assistance apparatus 100 with information on a road on which the vehicle 1 travels.

The driving device 20 may move the vehicle 1 and include, for example, an engine, an engine management system (EMS), a transmission, and a transmission control unit (TCU). The engine may generate a power for the vehicle 1 to travel, and the EMS may control the engine in response to a driver's acceleration intention through an accelerator pedal or a request of the driver assistance apparatus 100. The transmission may transmit the power generated by the engine to wheels for deceleration, and the TCU may control the transmission in response to a driver's transmission instruction through a transmission lever and/or a request of the driver assistance apparatus 100.

The braking device 30 may stop the vehicle 1 and include, for example, a brake caliper and a brake control module (EBCM). The brake caliper may decelerate the vehicle 1 or stop the vehicle 1 using friction with a brake disk, and the EBCM may control the brake caliper in response to a driver's braking intention through a brake pedal and/or a request of the driver assistance apparatus 100. For example, the EBCM may receive a deceleration request including a deceleration from the driver assistance apparatus 100 and electrically or hydraulically control the brake caliper so that the vehicle 1 decelerates depending on the requested deceleration.

The steering device 40 may include an electronic power steering control module (EPS). The steering device 40 may change a traveling direction of the vehicle 1, and the EPS may assist an operation of the steering device 40 so that the driver may easily manipulate a steering wheel in response to a driver's steering intention through a steering wheel. In addition, the EPS may control the steering device in response to a request of the driver assistance apparatus 100. For example, the EPS may receive a steering request including a steering torque from the driver assistance apparatus 100 and control the steering device to steer the vehicle 1 depending on the requested steering torque.

The display device 50 may include a cluster, a head-up display, a center fascia monitor, etc. and provide various pieces of information and entertainments to the driver through images and sounds. For example, the display device 50 may provide traveling information of the vehicle 1, a warning message, etc. to the driver.

The audio device 60 may include a plurality of speakers and provide various pieces of information and entertainments to the driver through sounds. For example, the audio device 60 may provide traveling information of the vehicle 1, a warning message, etc. to the driver.

The behavior sensor 70 may acquire behavior data representing the movement of the vehicle 1. For example, the behavior sensor 70 may include a speed sensor for detecting a wheel speed, an acceleration sensor for detecting a transverse acceleration and a longitudinal acceleration of the vehicle 1, a yaw rate sensor for detecting a yaw rate of the vehicle, a steering angle sensor for detecting an steering angle of a steering wheel, a torque sensor for detecting a steering torque of the steering wheel, and/or a turn signal lamp sensor for detecting operation information of a turn signal lamp. The behavior data may include the wheel speed, the transverse acceleration, the longitudinal acceleration, the yaw rate, the steering angle, the steering torque, and/or the operation information of the turn signal lamp.

The driver assistance apparatus 100 may communicate with the navigation device 10, the driving device 20, the braking device 30, the steering device 40, the display device 50, the audio device 60, and the behavior sensor 70 via the vehicle communication network. The driver assistance apparatus 100 may receive information on the route to the destination and the position information of the vehicle 1 from the navigation device 10 and acquire information on the wheel speed, transverse acceleration, the longitudinal acceleration, the yaw rate, the steering angle, the steering torque, and/or the operation information of the turn signal lamp of the vehicle 1 from the behavior sensor 70.

The driver assistance apparatus 100 may provide various functions for safety to the driver. For example, the driver assistance apparatus 100 may provide an adaptive cruise control (ACC) function and an intelligent speed limit assist (ISLA) function. In addition, the driver assistance apparatus 100 may provide functions of lane departure warning (LDW), lane keeping assist (LKA), high beam assist (HBA), autonomous emergency braking (AEB), traffic sign recognition (TSR), blind spot detection (BSD), traffic jam assist (TJA), etc.

The driver assistance apparatus 100 may include a camera 110, a radar 120, a light detection and ranging (LiDAR) 130, and a controller 140. The driver assistance apparatus 100 is not limited to one illustrated in FIG. 1. For example, at least one detector of the camera 110, the radar 120, or the LiDAR 130 is omitted from the driver assistance apparatus 100 illustrated in FIG. 1, or various detectors capable of detecting nearby objects of the vehicle 1 may be added thereto.

The camera 110, the radar 120, the LiDAR 130, and the controller 140 may be provided separately from one another. For example, the controller 140 may be installed in a housing separated from a housing of the camera 110, a housing of the radar 120, and a housing of the LiDAR 130. The controller 140 may exchange data with the camera 110, the radar 120, or the LiDAR 130 through a wide-bandwidth network.

At least some of the camera 110, the radar 120, the LiDAR 130, and the controller 140 may be integrally provided. For example, the camera 110 and the controller 140 may be provided in one housing, the radar 120 and the controller 140 may be provided in one housing, or the LiDAR 130 and the controller 140 may be provided in one housing.

The camera 110 may capture surroundings of the vehicle 1 and acquire image data of the surroundings of the vehicle 1. For example, as illustrated in FIG. 2, the camera 110 may be installed on a front windshield of the vehicle 1 and may have a forward field of view 110a of the vehicle 1.

The camera 110 may include a plurality of lenses and an image sensor. The image sensor may include a plurality of photodiodes for converting light into electrical signals, and the plurality of photodiodes may be disposed in the form of a two-dimensional matrix.

The image data may include information on another vehicle, a pedestrian, a cyclist, or a lane line positioned around the vehicle 1.

The driver assistance apparatus 100 may include an image processor for processing the image data of the camera 110, and the image processor may be, for example, provided integrally with the camera 110 or integrally with the controller 140.

The image processor may acquire image data from an image sensor of the camera 110 and detect and identify nearby objects of the vehicle 1 based on a result of processing the image data. For example, the image processor may generate tracks representing nearby objects of the vehicle 1 by image processing and may classify the tracks. The image processor may identify whether the track is another vehicle, a pedestrian, or a cyclist, etc. and give an identification code to the track.

The image processor may transmit data (or positions and classifications of the tracks) on tracks around the vehicle 1 (hereinafter referred to as “camera track”) to the controller 140.

The radar 120 may transmit transmission radio waves toward the surroundings of the vehicle 1 and detect the nearby objects of the vehicle 1 based on reflection radio waves reflected from the nearby objects. For example, as illustrated in FIG. 2, the radar 120 may be installed on a grille or a bumper of the vehicle 1 and may have a field of sensing 120a facing the front of the vehicle 1.

The radar 120 may include a transmission antenna (or a transmission antenna array) for radiating transmission radio waves toward the surroundings of the vehicle 1 and a reception antenna (or a reception antenna array) for receiving reflection radio waves reflected from objects.

The radar 120 may acquire radar data from the transmission radio waves transmitted by the transmission antenna and the reflection radio waves received by the reception antenna. The radar data may include position information (e.g., distance information) and/or speed information of objects positioned in front of the vehicle 1.

The driver assistance apparatus 100 may include a signal processor for processing the radar data of the radar 120, and the signal processor may be, for example, provided integrally with the radar 120 or integrally with the controller 140.

The signal processor may acquire the radar data from the reception antenna of the radar 120 and generate tracks representing the objects by clustering reflection points of a reflection signal. The signal processor may, for example, acquire a distance of the track based on a time difference between a transmission time of the transmission radio wave and a reception time of the reflection radio wave and acquire a relative speed of the track based on a difference between a frequency of the transmission radio wave and a frequency of the reflection radio wave.

The signal processor may transmit data (or the distances and relative speeds of the tracks) on the tracks around the vehicle 1 acquired from the radar data (hereinafter referred to as “radar track”) to the controller 140.

The LiDAR 130 may emit light (e.g., infrared rays) toward the surroundings of the vehicle 1 and detect nearby objects of the vehicle 1 based on reflection light reflected from the nearby objects. For example, as illustrated in FIG. 2, the LiDAR 130 may be installed on a roof of the vehicle 1 and may have a field of view 130a of the vehicle 1 in all directions.

The LiDAR 130 may include a light source (e.g., a light emitting diode, a light emitting diode array, a laser diode, or a laser diode array) for emit light (e.g., infrared light) and an optical sensor (e.g., a photodiode or a photodiode array) for receiving light (e.g., infrared rays). In addition, as necessary, the LiDAR 130 may further include a driving device for rotating the light source and/or the optical sensor.

While the light source and/or the optical sensor rotates, the LiDAR 130 may emit light through the light source and receive the light reflected from objects through the optical sensor, thereby acquiring LiDAR data.

The LiDAR data may include relative positions (distances and/or directions of nearby objects) and/or relative speeds of the nearby objects of the vehicle 1.

The driver assistance apparatus 100 may include a signal processor capable of processing the LiDAR data of the LiDAR 130, and the signal processor may be, for example, provided integrally with the LiDAR 130 or integrally with the controller 140.

The signal processor may generate tracks representing objects by clustering reflection points by the reflected light. The signal processor may, for example, acquire a distance to the object based on a time difference between a light transmission time and a light reception time. In addition, the signal processor may acquire a direction (or an angle) of the object with respect to a traveling direction of the vehicle 1 based on a direction in which the light source emits light when the optical sensor receives the reflected light.

The signal processor may transmit data (or the distances and relative speeds of the tracks) on the tracks around the vehicle 1 acquired from the LiDAR data (hereinafter referred to as “LiDAR track”) to the controller 140.

The controller 140 may be electrically connected to the camera 110, the radar 120, and/or the LiDAR 130. In addition, the controller 140 may be connected to the navigation device 10, the driving device 20, the braking device 30, the steering device 40, the display device 50, the audio device 60, and/or the behavior sensor 70 via the vehicle communication network NT.

The controller 140 may process the camera track (or the image data) of the camera 110, the radar track (or the radar data) of the radar 120, and the LiDAR track (or the LiDAR data) of the LiDAR 130 and provide control signals to the driving device 20, the braking device 30, and/or the steering device 40.

The controller 140 may include a processor 141 and a memory 142.

The memory 142 may store programs and/or data for processing the image data, the radar data, and/or the LiDAR data. In addition, the memory 142 may store programs and/or data for generating driving, braking, and steering signals.

The memory 142 may temporarily store the image data received from the camera 110, the radar data received from the radar 120, and the LiDAR data received from the LiDAR 130 and temporarily store the processing results of the image data, the radar data, and/or the LiDAR data of the processor 141.

In addition, the memory 142 may include a high definition (HD) map. Unlike general maps, the HD map may include detailed information on surfaces of roads or intersections, such as lane lines, traffic lights, intersections, and traffic signs. In particular, landmarks (e.g., lane lines, traffic lights, intersections, and traffic signs) that vehicles encounters while traveling are implemented in a three dimension on the HD map.

The memory 142 may include both volatile memories such as a static random access memory (SRAM) and a dynamic RAM (DRAM) and non-volatile memories such as a flash memory, a read only memory (ROM), and an erasable programmable ROM (EPROM).

The processor 141 may process the camera track of the camera 110, the radar track of the radar 120, and/or the LiDAR track of the LiDAR 130. For example, the processor 141 may fuse the camera track, the radar track, and/or the LiDAR track and output fusion track.

Based on a result of processing the fusion tracks, the processor 141 may generate a driving signal, a braking signal, and/or a steering signal for respectively controlling the driving device 20, the braking device 30, and/or the steering device 40. For example, the processor 141 may evaluate risk of a collision between the fusion tracks and the vehicle 1. The processor 141 may control the driving device 20, the braking device 30, and/or the steering device 40 to steer or brake the vehicle 1 based on the risk of collision between the fusion tracks and the vehicle 1.

The processor 141 may include the image processor for processing the image data of the camera 110, the signal processor for processing the radar data of the radar 120 and/or the LiDAR data of the LiDAR 130 or a micro control unit (MCU) for generating driving, braking, and steering signals.

As described above, the controller 140 may provide the driving signal, the braking signal, or the steering signal based on the image data of the camera 110, the radar data of the radar 120, or the LiDAR data of the LiDAR 130.

Hereinafter, a description will be given based on a traveling situation of a vehicle in a road environment in which a vehicle travels on a left-hand side (e.g., Australia, Japan, and United of Kingdom).

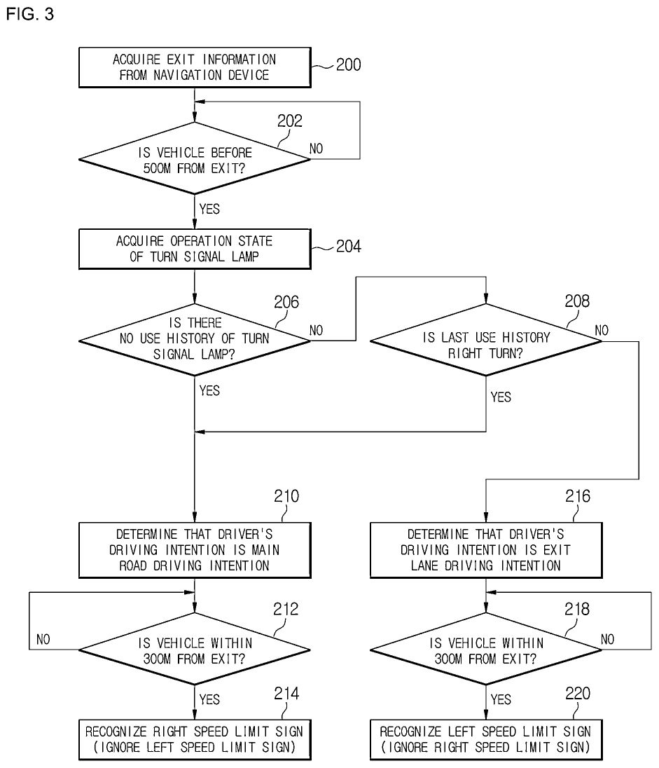

FIG. 3 is a flowchart illustrating an operation of the driver assistance apparatus in accordance with one embodiment.

Referring to FIG. 3, the driver assistance apparatus 100 ignores a speed limit sign in a direction in which the vehicle 1 does not travel and recognizes only a speed limit sign in a traveling direction by identifying a driver's driving intention before reaching a branch section in which a road on which the vehicle 1 travels is branched into a main road and an exit lane and predicting a traveling direction from the driver's driving intention.

First, the driver assistance apparatus 100 acquires information on an exit of the road on which the vehicle 1 travels from the navigation device 10 (200). The exit is information on an exit at which the vehicle 1 may continuously travel on the main road or exit to an exit lane.

The driver assistance apparatus 100 determines, for example, whether the vehicle 1 is 500 m ahead of the exit according to the information on the exit provided by the navigation device 10 (202). In general, the navigation device 10 may output a forward branch signal indicating that the road is branched ahead when the vehicle 1 is 500 m before the exit of the road on which the vehicle travels according to road information, and the controller 140 may receive the forward branch signal output from the navigation device 10 and identify whether the vehicle 1 is 500 m before the exit ahead according to the front branch signal.

The driver assistance apparatus 100 acquires an operation state of a turn signal lamp mounted on the vehicle (204).

The controller 140 may detect an operation of a turn signal lamp switch manipulated by a driver to identify whether the turn signal lamp operates and, when the turn signal lamp is operating, identify whether a left turn signal lamp is operating or a right turn signal lamp is operating. At this time, the driver assistance apparatus 100 may store the last use history of the turn signal lamp. The controller 140 may register the last use history indicating whether the operation state of the turn signal lamp is a state in which the left turn signal lamp is turned on or the right turn signal lamp is turned on in the memory 142 and acquire the last use history of the turn signal lamp registered in the memory 142 at a necessary time point. The last use history of the turn signal lamp registered in the memory 142 may be deleted after a preset time has elapsed.

The driver assistance apparatus 100 identifies whether there is no use history of the turn signal lamp based on the operation state and the last use history of the turn signal lamp (206).

When there is the use history of the turn signal lamp (NO in 206), the driver assistance apparatus 100 identifies whether the last use history of the turn signal lamp is a right turn (208).

When there is no use history of the turn signal lamp (YES in 206) or when the last use history of the turn signal lamp is a right turn (YES in 208), the driver assistance apparatus 100 determines that the driver's driving intention is main road driving intention (210). That is, when the turn signal lamp is not in use or the right turn signal lamp is operating, it may be determined that the driver's driving intention is the main road driving intention because the possibility that the driver continuously drives on the main road at the exit is higher than the possibility that the driver exits to the exit lane.

When it is determined that the driver's driving intention is the main road driving intention, a driving direction desired by the driver at the exit may be predicted. That is, the driving direction desired by the driver at the exit may be predicted as the main road driving direction.

The driver assistance apparatus 100 identifies whether the vehicle is, for example, within 300 m from the exit (212). In general, a speed limit sign is installed around 300 m from the exit.

When the vehicle is within 300 m from the exit, the driver assistance apparatus 100 recognizes only a speed limit of a right speed limit sign positioned at the right side of a driving road (214). At this time, the driver assistance apparatus 100 defers the identification of a speed limit of a left speed limit sign positioned at the left side of the driving road or ignores the speed limit. At this time, when the vehicle enters within a preset distance from the exit, the forward branch signal output from the navigation device 10 is changed from “Frwinfo=0x2 (exit)” to “Frwinfo=0x0 (none).” When the forward branch signal is changed from “Frwinfo=0x2 (exit)” to “Frwinfo=0x0 (none)” and the vehicle is within 300 m from the exit, the driver assistance apparatus 100 may recognize only the speed limit of the right speed limit sign positioned at the right side of the driving road.

The controller 140 selects a speed limit sign corresponding to the main road driving direction predicted as the driver's driving direction at the exit among a plurality of speed limit signs installed on the driving road and recognizes only a speed limit of the selected speed limit sign. That is, the controller 140 may recognize only the speed limit of the main road, warn the driver of the speed limit according to the recognized speed limit, and automatically controlling an ACC system to change the driving speed to the speed limit.

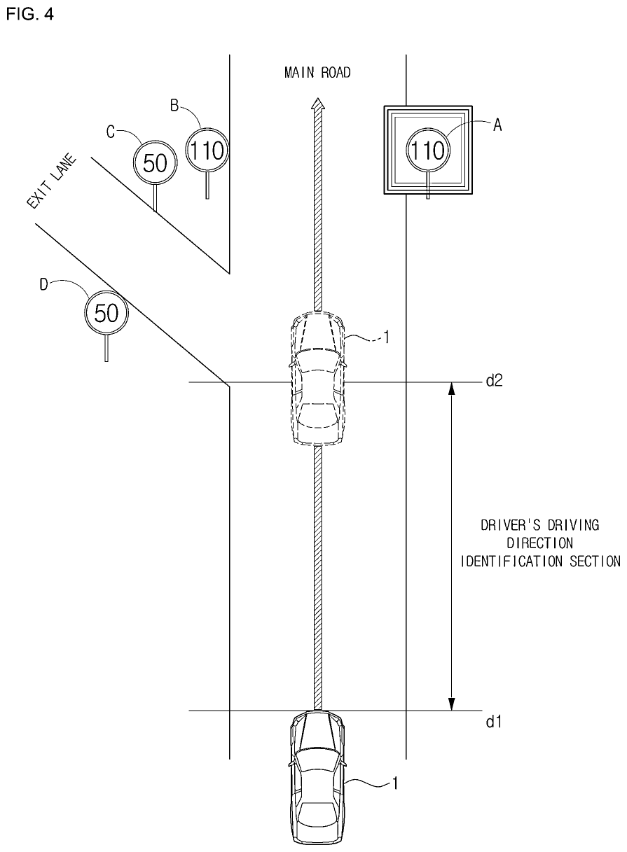

FIG. 4 is a view illustrating recognizing a speed limit sign when the driver assistance apparatus in accordance with one embodiment predicts that a vehicle travels on a main road at an exit.

Referring to FIG. 4, it is illustrated that the road on which the vehicle 1 travels is branched into a main road, which is a straight road, and an exit lane at which the vehicle may exit to a left side at an exit ahead.

Speed limit signs A and B of a speed limit of 110 km are respectively installed at the left and right sides of the main road. Speed limit signs C and D of a speed limit of 50 km are respectively installed at the left and right sides of the exit lane.

When receiving forward branch information from the navigation device 10 at d1 (e.g., 500 m) from the exit, the driver assistance apparatus 100 predicts whether the driver's driving direction is the main road driving direction or the exit lane traveling direction at the exit in a driver's driving direction identification section (d1 to d2).

When the turn signal lamp is not in use or when the last use history of the turn signal lamp is a right turn in the driver's driving direction identification section (d1 to d2), the driver assistance apparatus 100 determines that the driver's driving intention is the main road driving intention and predicts the driver's driving direction as the main road driving direction at the exit.

In addition, in a section that is within 300 m from the exit at which the speed limit signs A, B, C, and D on the road start to be visible, the driver assistance apparatus 100 recognizes only the speed limit of the right speed limit sign A corresponding to the main road driving direction predicted as the driver's driving direction and ignores the remaining speed limit signs B, C, and D, particularly, the left speed limit signs C and D corresponding to the exit lane driving direction. The driver assistance apparatus 100 acquires image data of the right speed limit sign A through the camera 110 and recognizes the speed limit of the right speed limit sign A from the image data of the right speed limit sign A.

As illustrated in FIG. 4, it can be seen that only the speed limit sign A recognized by the driver assistance apparatus 100 is highlighted, and the remaining speed limit signs B, C, and D ignored by the driver assistance apparatus 100 are not highlighted.

Therefore, the driver assistance apparatus 100 performs the ISLA function and/or the ACC function of the vehicle 1 based on a speed limit of 110 km.

Referring back to FIG. 3, meanwhile, when the last use history of the turn signal lamp is not a right turn (NO in 208), the driver assistance apparatus 100 identifies that the last use history of the turn signal lamp is a left turn and determines that the driver's driving intention is the exit lane driving intention (216). That is, the driver assistance apparatus 100 determines that the driver's driving intention is the exit lane driving intention when the left turn signal lamp is operating.

The driver assistance apparatus 100 identifies whether the vehicle is, for example, within 300 m from the exit (218).

When the vehicle is within 300 m from the exit, the driver assistance apparatus 100 recognizes only a speed limit of a left speed limit sign positioned at the left side of a driving road (220). At this time, the driver assistance apparatus 100 ignores a speed limit of a right speed limit sign positioned at the right side of the driving road. At this time, when the forward branch signal is changed from “Frwinfo=(exit)” to “Frwinfo=0x0 (none)” and the vehicle is within 300 m from the exit, the driver assistance apparatus 100 may recognize only the speed limit of the left speed limit sign positioned at the left side of the driving road.

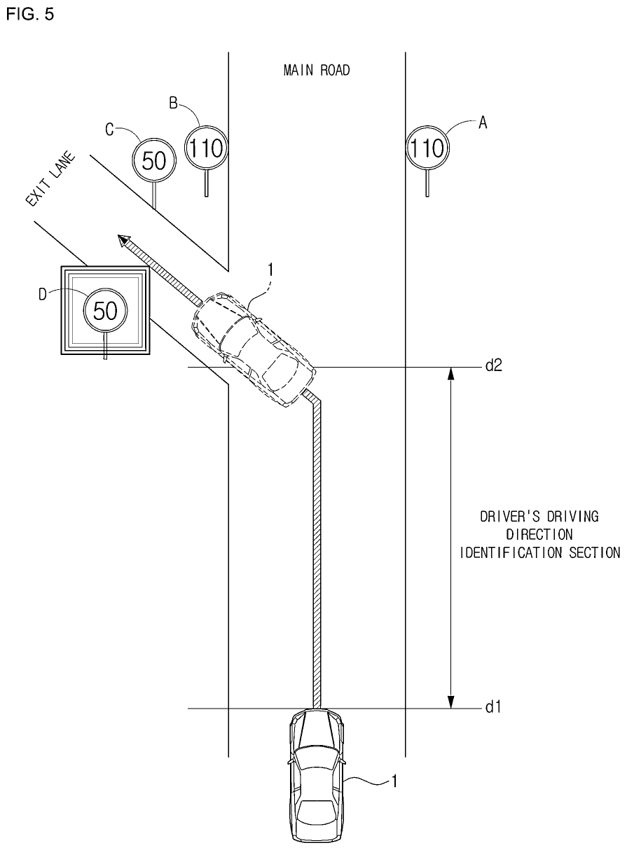

FIG. 5 is a view illustrating recognizing a speed limit sign when the driver assistance apparatus in accordance with one embodiment predicts that a vehicle exits to an exit lane.

Referring to FIG. 5, when the last use history of the turn signal lamp is a left turn in the driver's driving direction identification section (d1 to d2), the driver assistance apparatus 100 determines that the driver's driving intention is the exit lane driving intention and predicts the driver's driving direction as the exit lane driving direction at the exit.

In addition, in the section that is, for example, within 300 m from the exit, the driver assistance apparatus 100 recognizes only the speed limit of the left speed limit sign D corresponding to the exit lane driving direction predicted as the driver's driving direction and ignores the remaining speed limits A, B, and C, particularly, the right speed limit signs A and B corresponding to the main road driving direction. As illustrated in FIG. 5, it can be seen that only the speed limit sign D recognized by the driver assistance apparatus 100 is highlighted, and the remaining speed limit signs A, B, and C ignored by the driver assistance apparatus 100 are not highlighted.

Therefore, the driver assistance apparatus 100 performs the ISLA function and/or the ACC function of the vehicle 1 based on a speed limit of 50 km.

Hereinafter, a description will be given based on a traveling situation of a vehicle in a road environment in which a vehicle travels on a right-hand side (e.g., South of Korea and the United States). This is a traveling situation opposite to the road environment in which the vehicle travels on the left-hand side.

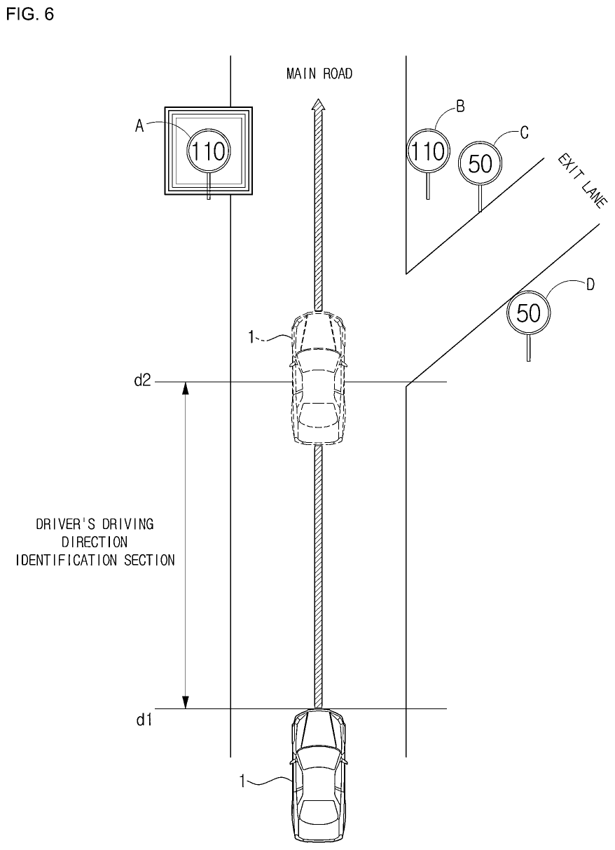

FIG. 6 is a view illustrating recognizing a speed limit sign when a driver assistance apparatus in accordance with another embodiment predicts that a vehicle travels on a main road at an exit.

Referring to FIG. 6, it is illustrated that the road on which the vehicle 1 travels is branched into a main road, which is a straight road, and an exit lane at which the vehicle may exit to a left side at an exit ahead.

Speed limit signs A and B with a speed limit of 110 km are respectively installed at the left and right sides of the main road. Speed limit signs C and D with a speed limit of 50 km are respectively installed at the left and right sides of the exit lane.

When receiving forward branch information from the navigation device 10 at d1 (e.g., 500 m) from the exit, the driver assistance apparatus 100 predicts whether the driver's driving direction is the main road driving direction or the exit lane traveling direction at the exit in a driver's driving direction identification section (d1 to d2).

When the turn signal lamp is not in use or when the last use history of the turn signal lamp is a left turn in the driver's driving direction identification section (d1 to d2), the driver assistance apparatus 100 determines that the driver's driving intention is the main road driving intention and predicts the driver's driving direction as the main road driving direction at the exit.

In addition, in a section that is within 300 m from the exit at which the speed limit signs A, B, C, and D on the road start to be visible, the driver assistance apparatus 100 recognizes only the speed limit of the left speed limit sign A corresponding to the main road driving direction predicted as the driver's driving direction and ignores the remaining speed limit signs B, C, and D, particularly, the left speed limit signs C and D corresponding to the exit lane driving direction. As illustrated in FIG. 6, it can be seen that only the speed limit sign A recognized by the driver assistance apparatus 100 is highlighted, and the remaining speed limit signs B, C, and D ignored by the driver assistance apparatus 100 are not highlighted.

Therefore, the driver assistance apparatus 100 performs the ISLA function and/or the ACC function of the vehicle 1 based on a speed limit of 110 km.

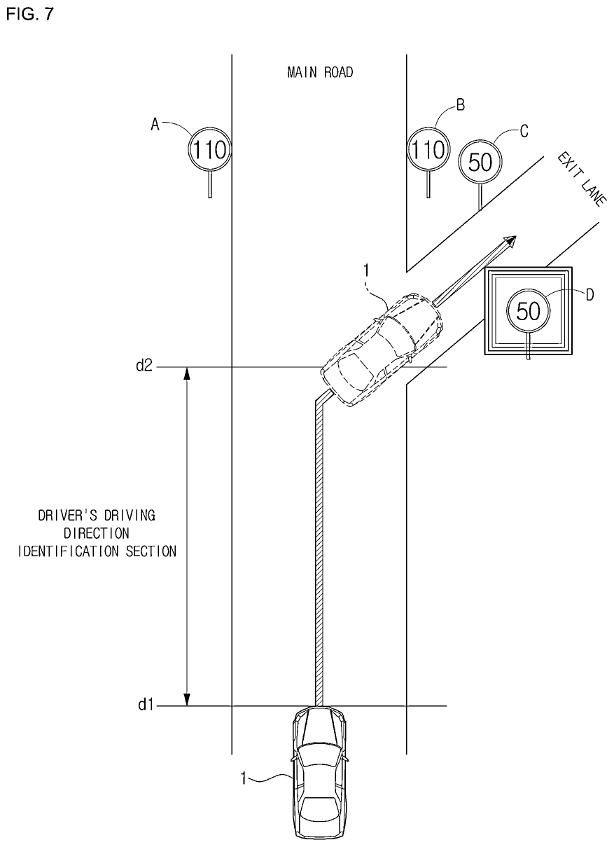

FIG. 7 is a view illustrating recognizing a speed limit sign when the driver assistance apparatus in accordance with another embodiment predicts that a vehicle exits to an exit lane.

Referring to FIG. 7, when the last use history of the turn signal lamp is a right turn in the driver's driving direction identification section (d1 to d2), the driver assistance apparatus 100 determines that the driver's driving intention is the exit lane driving intention and predicts the driver's driving direction as the exit lane driving direction at the exit.

In addition, in the section that is, for example, within 300 m from the exit, the driver assistance apparatus 100 recognizes only the speed limit of the right speed limit sign D corresponding to the exit lane driving direction predicted as the driver's driving direction and ignores the remaining speed limits A, B, and C, particularly, the right speed limit signs A and B corresponding to the main road driving direction. As illustrated in FIG. 7, it can be seen that only the speed limit sign D recognized by the driver assistance apparatus 100 is highlighted, and the remaining speed limit signs A, B, and C ignored by the driver assistance apparatus 100 are not highlighted.

Therefore, the driver assistance apparatus 100 performs the ISLA function and/or the ACC function of the vehicle 1 based on a speed limit of 50 km.

As described above, the driver assistance apparatus 100 can predict the driver's driving direction at the exit in the exit section and recognize the road limit speed in the predicted direction as the speed limit of the vehicle, thereby accurately recognizing the road speed limit suitable for the driver's driving direction and reducing misrecognition of the speed limit.

Meanwhile, the term “recognition” described above may be replaced with the term “identification.”

As is apparent from the above description, by accurately recognizing a road speed limit suitable for a driver's driving direction at an exit in an exit section, it is possible to reduce misrecognition of the speed limit.

By predicting the driver's driving direction at the exit in the exit section and recognizing the road limit speed in the predicted direction as a speed limit of a vehicle, it is possible to accurately recognize the road speed limit suitable for the driver's driving direction, thereby reducing misrecognition of the speed limit.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. An apparatus for driver assistance comprising:
a camera installed in a vehicle, having a forward field of view of the vehicle, and configured to acquire image data; and
a controller configured to process the image data,
wherein the controller is configured to:
identify whether the vehicle exits from a road at an exit of the road on which the vehicle travels;
identify a plurality of speed limit signs from the image data;
select a speed limit sign to identify a speed limit among the plurality of speed limit signs based on whether the vehicle exits from the road; and
identify a speed limit of the selected speed limit sign.

2. The apparatus of claim 1, wherein the controller is configured to identify whether the vehicle exits from the road at the exit based on at least one of an operation state or a last use history of a turn signal lamp of the vehicle.

3. The apparatus of claim 2, wherein, in a road environment in which the vehicle travels on a left-hand side, the controller is configured to identify that the vehicle does not exit from the road based on a fact that the turn signal lamp is not in use or that the last use history of the turn signal lamp is a right turn.

4. The apparatus of claim 3, wherein the controller is configured to select only a right speed limit sign among the plurality of speed limit signs, which is located to a right side of a main road, based on a result of identifying that the vehicle does not exit from the road and ignores the remaining speed limit signs.

5. The apparatus of claim 2, wherein, in a road environment in which the vehicle travels on a left-hand side, the controller is configured to identify that the vehicle exits from the road based on a fact that the last use history of the turn signal lamp is a left turn.

6. The apparatus of claim 5, wherein the controller is configured to select only a left speed limit sign among the plurality of speed limit signs, which is located to a left side of an exit lane, based on a result of identifying that the vehicle exits from the road and ignores the remaining speed limit signs.

7. The apparatus of claim 2, wherein, in a road environment in which the vehicle travels on a right-hand side, the controller is configured to identify that the vehicle does not exit from the road based on a fact that the turn signal lamp is not in use or that the last use history of the turn signal lamp is a left turn.

8. The apparatus of claim 7, wherein the controller is configured to select only a left speed limit sign among the plurality of speed limit signs, which is located to a left side of a main road, based on a result of identifying that the vehicle does not exit from the road and ignores the remaining speed limit signs.

9. The apparatus of claim 2, wherein, in a road environment in which the vehicle travels on a right-hand side the controller is configured to identify that the vehicle exits from the road based on a fact that the last use history of the turn signal lamp is a right turn.

10. The apparatus of claim 9, wherein the controller is configured to select only a right speed limit sign among the plurality of speed limit signs, which is located to a right side of an exit lane, based on a result of identifying that the vehicle exits from the road and ignores the remaining speed limit signs.

11. A method for driver assistance comprising:
identifying whether a vehicle exits from a road at an exit of the road on which the vehicle travels;
acquiring image data through a camera having a forward field of view of the vehicle;
identifying a plurality of speed limit signs from the image data;
selecting a speed limit sign to identify a speed limit among the plurality of speed limit signs based on whether the vehicle exits from the road; and
identifying a speed limit of the selected speed limit sign.

12. The method of claim 11, wherein the identifying of whether the vehicle exits from the road comprises identifying whether the vehicle exits from the road at the exit based on at least one of an operation state or a last use history of a turn signal lamp of the vehicle.

13. The method of claim 12, wherein the identifying of whether the vehicle exits from the road comprises, in a road environment in which the vehicle travels on a left-hand side, identifying that the vehicle does not exit from the road based on a fact that the turn signal lamp is not in use or that the last use history of the turn signal lamp is a right turn.

14. The method of claim 13, wherein the selecting of the speed limit sign to identify the speed limit comprises selecting only a right speed limit sign among the plurality of speed limit signs, which is located to a right side of a main road, based on the identifying that the vehicle does not exit from the road and ignoring the remaining speed limit signs.

15. The method of claim 12, wherein the identifying of whether the vehicle exits from the road comprises, in a road environment in which the vehicle travels on a left-hand side, identifying that the vehicle exits from the road based on a fact that the last use history of the turn signal lamp is a left turn.

16. The method of claim 15, wherein the selecting of the speed limit sign to identify the speed limit comprises selecting only a left speed limit sign among the plurality of speed limit signs, which is located to a left side of an exit lane, based on the identifying that the vehicle exits from the road and ignoring the remaining speed limit signs.

17. The method of claim 12, wherein the identifying of whether the vehicle exits from the road comprises, in a road environment in which the vehicle travels on a right-hand side, identifying that the vehicle does not exit from the road based on a fact that the turn signal lamp is not in use or that the last use history of the turn signal lamp is a left turn.

18. The method of claim 17, wherein the selecting of the speed limit sign to identify the speed limit comprises selecting only a left speed limit sign among the plurality of speed limit signs, which is located to a left side of a main road, based on the identifying that the vehicle does not exit from the road and ignoring the remaining speed limit signs.

19. The method of claim 12, wherein the identifying of whether the vehicle exits from the road comprises, in a road environment in which the vehicle travels on a right-hand side, identifying that the vehicle exits from the road based on a fact that the last use history of the turn signal lamp is a right turn.

20. The method of claim 19, wherein the selecting of the speed limit sign to identify the speed limit comprises selecting only a right speed limit sign among the plurality of speed limit signs, which is located to a right side of an exit lane, based on the identifying that the vehicle exits from the road and ignoring the remaining speed limit signs.
